(19) United States
(12) Patent Application Publication
(10) Pub. No.: US 2023/0204776 A1
(43) Pub. Date: Jun. 29, 2023

(54) VEHICLE LIDAR SYSTEM AND OBJECT DETECTION METHOD THEREOF

(71) Applicants: Hyundai Motor Company, Seoul (KR); Kia Corporation, Seoul (KR)

(72) Inventor: Yoon Seok Yang, Yongin (KR)

(21) Appl. No.: 18/071,272

(22) Filed: Nov. 29, 2022

(30) Foreign Application Priority Data
Dec. 29, 2021 (KR) 10-2021-0191763

(51) Int. Cl. G01S 17/89; G01S 17/50

(52) U.S. Cl. CPC G01S 17/89; G01S 17/50

(57) ABSTRACT

An object detection method of a vehicle LiDAR system may be disclosed. The object detection method includes calculating, based on LiDAR point data of a previous time point and LiDAR point data of a current time point of an object to track, a representative vector value representing a movement variation of the LiDAR point data from the previous time point to the current time point; and extracting heading information of the object to track based on the representative vector value.

### PRIORITY

The present application claims the benefit under 35 U.S.C. § 119(a) of Korean Patent Application No. 10-2021-0191763, filed on Dec. 29, 2021, which is hereby incorporated by reference as if fully set forth herein.

### BACKGROUND OF THE DISCLOSURE

### Field of the Disclosure

The present disclosure relates to a vehicle LiDAR system and an object detection method thereof.

### Discussion of the Related Art

LiDAR (Light Detection And Ranging) has been developed in the form of constructing topographic data for constructing three-dimensional GIS (geographic information system) information and visualizing the topographic data. A LiDAR system may obtain information on a surrounding object, such as a target vehicle, by using a LiDAR sensor, and may assist in the autonomous driving function of a vehicle equipped with the LiDAR sensor (hereinafter, referred to as a ‘host vehicle’), by using the obtained information.

If information on an object recognized using the LiDAR sensor may be inaccurate, the reliability of autonomous driving may decrease, and the safety of a driver may be jeopardized. Thus, research to improve the accuracy of detecting an object has continued.

### SUMMARY OF THE DISCLOSURE

An object of the present disclosure may be to provide a vehicle LiDAR system and an object detection method thereof, capable of accurately obtaining heading information of an object.

It may be to be understood that technical objects to be achieved by embodiments may not be limited to the aforementioned technical objects and other technical objects which may not be mentioned herein will be apparent from the following description to one of ordinary skill in the art to which the present disclosure pertains.

To achieve the objects and other advantages and in accordance with the purpose of the disclosure, an object detection method of a vehicle LiDAR system may include: calculating, on the basis of LiDAR point data of a previous time point and LiDAR point data of a current time point of an object to track, a representative vector value representing a movement variation of the LiDAR point data from the previous time point to the current time point; and extracting heading information of the object to track on the basis of the representative vector value.

For example, the calculating of, on the basis of the LiDAR point data of the previous time point and the LiDAR point data of the current time point of the object to track, the representative vector value representing the movement variation of the LiDAR point data from the previous time point to the current time point may include: collecting the LiDAR point data of the previous time point and the current time point of the object to track; sampling, on the basis of the LiDAR point data, data of an outline of the object to track of the previous time point and an outline of the object to track of the current time point; and calculating a vector value capable of fitting sampling data of the previous time point on the basis of sampling data of the current time point, as the representative vector value.

For example, the collecting of the LiDAR point data of the previous time point and the current time point of the object to track may include: obtaining information on a shape box of a three-dimensional coordinate system of the object to track; and obtaining contour information of a three-dimensional coordinate system associated with the shape box of the three-dimensional coordinate system.

For example, the sampling of, on the basis of the LiDAR point data, the data of the outline of the object to track of the previous time point and the outline of the object to track of the current time point may include: converting the contour information of the three-dimensional coordinate system of each of the previous time point and the current time point into contour information of a two-dimensional coordinate system; and sampling the data of the outline on the basis of the contour information converted into the two-dimensional coordinate system.

For example, the sampling of the data of the outline on the basis of the contour information converted into the two-dimensional coordinate system may include: sampling the data of the outline by performing Graham scan for the contour information.

For example, the calculating of the vector value capable of fitting the sampling data of the previous time point on the basis of the sampling data of the current time point, as the representative vector value may include: fixing the data of the outline of the current time point as reference data; and calculating a vector value enabling the data of the outline of the previous time point to be fitted to the data of the outline of the current time point while having a minimum error, as the representative vector value.

For example, the calculating of the vector value capable of fitting the sampling data of the previous time point on the basis of the sampling data of the current time point, as the representative vector value may include: inputting the data of the outline of the current time point and the data of the outline of the previous time point, as inputs of an iterative closest point (ICP) filter; and applying an output of the ICP filter as the representative vector value.

For example, the extracting of the heading information of the object to track on the basis of the representative vector value may include: setting the heading information to a direction the same as the representative vector value.

In another embodiment of the present disclosure, a computer-readable recording medium recorded with a program for executing an object detection method of a vehicle LiDAR system may implement: a function of calculating, on the basis of LiDAR point data of a previous time point and LiDAR point data of a current time point of an object to track, a representative vector value representing a movement variation of the LiDAR point data from the previous time point to the current time point; and a function of extracting heading information of the object to track on the basis of the representative vector value.

In still another embodiment of the present disclosure, a vehicle LiDAR system may include: a LiDAR sensor; and a LiDAR signal processing device configured to calculate, on the basis of LiDAR point data of a previous time point and LiDAR point data of a current time point of an object to track obtained through the LiDAR sensor, a representative vector value representing a movement variation of the LiDAR point data from the previous time point to the current time point, and extract heading information of the object to track on the basis of the representative vector value.

For example, the LiDAR signal processing device may be configured to collect the LiDAR point data of the previous time point and the current time point of the object to track, may sample, on the basis of the LiDAR point data, data of an outline of the object to track of the previous time point and an outline of the object to track of the current time point, and then, may be configured to calculate a vector value capable of fitting sampling data of the previous time point on the basis of sampling data of the current time point, as the representative vector value.

For example, the LiDAR signal processing device may be configured to obtain information on a shape box of a three-dimensional coordinate system of the object to track, and may obtain contour information of a three-dimensional coordinate system associated with the shape box of the three-dimensional coordinate system.

For example, the LiDAR signal processing device may be configured to convert the contour information of the three-dimensional coordinate system of each of the previous time point and the current time point into contour information of a two-dimensional coordinate system, and may be configured to sample the data of the outline on the basis of the contour information converted into the two-dimensional coordinate system.

For example, the LiDAR signal processing device may be configured to sample the data of the outline by performing Graham scan for the contour information.

For example, the LiDAR signal processing device may be configured to fix the data of the outline of the current time point as reference data, and may calculate a vector value enabling the data of the outline of the previous time point to be fitted to the data of the outline of the current time point while having a minimum error, as the representative vector value.

For example, the LiDAR signal processing device may be configured to include an iterative closest point (ICP) filter which receives the data of the outline of the current time point and the data of the outline of the previous time point and outputs the representative vector value.

For example, the LiDAR signal processing device may be configured to set the heading information to a direction the same as the representative vector value.

An exemplary embodiment of the present disclosure includes a vehicle comprising the vehicle LiDAR system as described herein.

In the vehicle LiDAR system and the object detection method thereof according to the embodiments, by generating motion vectors using LiDAR points of an object at a current time point and a previous time point and extracting heading information of the object from the generated motion vectors, it may be possible to obtain accurate heading information even for an object whose shape change occurs greatly.

In addition, effects obtainable from the embodiments may not be limited by the above mentioned effects. Other unmentioned effects may be clearly understood from the following description by those having ordinary skill in the technical field to which the present disclosure pertains.

### BRIEF DESCRIPTION OF THE DRAWINGS

FIG. 1 is a block diagram of a vehicle LiDAR system according to an embodiment;

FIG. 2 is a flowchart of an object tracking method of the vehicle LiDAR system according to the embodiment;

FIG. 3 is a diagram for explaining a box detected by a LiDAR signal processing device of FIG. 1;

FIGS. 4 and 5 are diagrams for explaining heading information extraction methods according to comparative examples;

FIG. 6 is a schematic flowchart of a heading information extraction method according to an embodiment;

FIGS. 7A-7C, and 8A-8C are diagrams for explaining the heading information extraction method of FIG. 6;

FIG. 9 is a detailed flowchart of the heading information extraction method according to the embodiment; and

FIGS. 10 to 14 are diagrams for explaining the heading information extraction method of FIG. 9.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, embodiments will be described in detail with reference to the annexed drawings and description. However, the embodiments set forth herein may be variously modified, and it should be understood that there may be no intent to limit the present disclosure to the particular forms disclosed, but on the contrary, the embodiments may be to cover all modifications, equivalents, and alternatives falling within the spirit and scope of the present disclosure as defined by the claims. The embodiments may be provided to more completely describe the present disclosure to those skilled in the art.

In the following description of the embodiments, it will be understood that, when each element may be referred to as being formed “on” or “under” the other element, it may be directly “on” or “under” the other element or may be indirectly formed with one or more intervening elements therebetween.

Further, when an element may be referred to as being formed “on” or “under” another element, not only the upward direction of the former element but also the downward direction of the former element may be included.

In addition, it will be understood that, although the relational terms, such as “first”, “second”, “upper”, “lower”, etc., may be used herein to describe various elements, these terms neither require nor connote any physical or logical relations between substances or elements or the order thereof, and may be used only to discriminate one substance or element from other substances or elements.

Throughout the specification, when an element “includes” a component, this may indicate that the element does not exclude another component unless stated to the contrary, but may further include another component. In the drawings, parts irrelevant to the description may be omitted in order to clearly describe the present disclosure, and like reference numerals designate like parts throughout the specification.

According to the present embodiment, when detecting an object using a LiDAR (Light Detection And Ranging) sensor, motion vectors may be generated using LiDAR point data of an object at a current time point and a previous time point, and heading information of the object may be extracted on the basis of the generated motion vectors. Accordingly, accurate heading information may be obtained even for an object whose shape change occurs greatly.

Hereinafter, a vehicle LiDAR system and an object detection method thereof according to embodiments will be described with reference to the drawings.

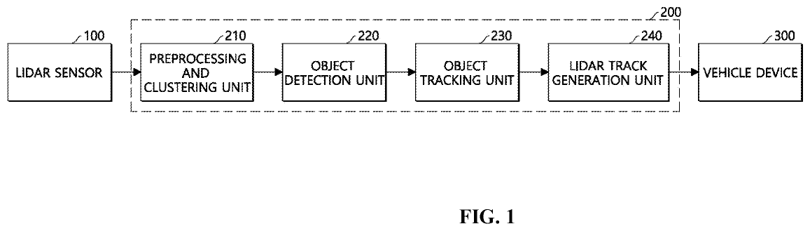

FIG. 1 is a block diagram of a vehicle LiDAR system according to an embodiment.

Referring to FIG. 1, the vehicle LiDAR system may include a LiDAR sensor 100, a LiDAR signal processing device 200 which processes data obtained from the LiDAR sensor 100 to output object tracking information, and a vehicle device 300 which controls various functions of a vehicle according to the object tracking information.

After irradiating a laser pulse to an object within a measurement range, by measuring a time during which the laser pulse reflected from the object returns, the LiDAR sensor 100 may be configured to sense information on the object, such as a distance to the object from the LiDAR sensor 100 and the direction, speed, temperature, material distribution and concentration property of the object. The object may be another vehicle, a person, a thing, etc. existing outside the vehicle to which the LiDAR sensor 100 may be mounted, but the embodiment may not be limited to a specific type of the object. The LiDAR sensor 100 may output LiDAR point data composed of a plurality of points for a single object.

The LiDAR signal processing device 200 may be configured to receive LiDAR point data to recognize an object, may track the recognized object, and may classify the type of the object. The LiDAR signal processing device 200 may include a preprocessing and clustering unit 210, an object detection unit 220, an object tracking unit 230, and an object classification unit 240.

The preprocessing and clustering unit 210 may be configured to cluster the LiDAR point data received from the LiDAR sensor 100, after preprocessing the LiDAR point data into a processable form. The preprocessing and clustering unit 210 may be configured to preprocess the LiDAR point data by removing ground points. In addition, preprocessing may be performed such that the LiDAR point data may be converted in conformity with a reference coordinate system according to a position angle at which the LiDAR sensor 100 may be mounted and points with low intensity or reflectivity through the intensity or confidence information of the LiDAR point data may be removed through filtering. Furthermore, since there may be a region covered by the body of a host vehicle depending on the mounting position and viewing angle of the LiDAR sensor 100, the preprocessing and clustering unit 120 may be configured to remove data reflected by the body of the host vehicle by using the reference coordinate system. Since the preprocessing process for the LiDAR point data serves to refine valid data, a partial or entire preprocessing process may be omitted or another preprocessing process may be added. The preprocessing and clustering unit 210 may be configured to cluster the preprocessed LiDAR point data into meaningful units according to a predetermined rule. Since the LiDAR point data includes information such as position information, the preprocessing and clustering unit 210 may be configured to cluster a plurality of points into a meaningful shape unit, and may output the points to the object detection unit 220.

The object detection unit 220 may be configured to generate a contour using clustered points, and may be configured to determine the shape of an object on the basis of the generated contour. The object detection unit 220 may be configured to generate a shape box which fits the shape of the object, on the basis of the determined shape of the object. The object detection unit 220 may be configured to generate a shape box for a unit target object at a current time point (t), and may provide the shape box to the object tracking unit 230.

The object tracking unit 230 may be configured to generate a track box for tracking the object, based on the shape box generated by the object detection unit 220, and track the object by selecting a track box associated with the object which may be tracked. The object tracking unit 230 may be configured to obtain attribute information such as the heading of a track box by signal-processing LiDAR point data obtained from each of a plurality of LiDAR sensors 100. The object tracking unit 230 may be configured to perform signal-processing of obtaining such attribute information in each cycle. Hereinafter, a cycle for obtaining attribute information may be referred to as a ‘step.’ Information recognized in each step may be preserved as history information, and in general, information of a maximum of five steps may be preserved as history information.

The object classification unit 240 be configured to classify detected tracks into objects such as a pedestrian, a guardrail and an automobile, according to attribute information, and output the detected tracks to the vehicle device 300.

The vehicle device 300 may be provided with a LiDAR track from the LiDAR signal processing device 200, and may apply the LiDAR track to control a driving function.

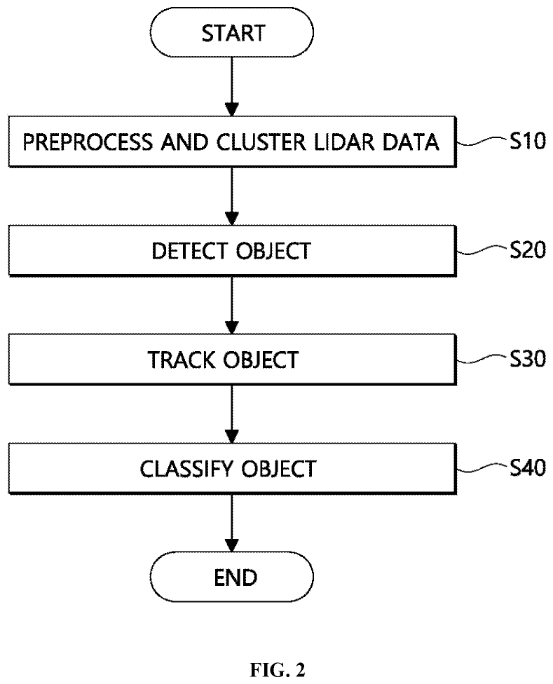

FIG. 2 is a flowchart of an object tracking method using a LiDAR sensor according to an embodiment.

The LiDAR signal processing device 200 clusters LiDAR point data received from the LiDAR sensor 100, after preprocessing the LiDAR point data into a processable form (S10). The preprocessing and clustering unit 210 may perform a preprocessing process of removing ground data from the LiDAR point data, and may cluster the preprocessed LiDAR point data into a meaningful shape unit, that is, a point unit of a part considered to be the same object.

An object may be detected on the basis of clustered points (S20). The object detection unit 220 may generate a contour using the clustered points, and may generate and output a shape box according to the shape of the object on the basis of the generated contour.

The object may be tracked on the basis of the detected box (S30). The object tracking unit 230 tracks the object by generating a track box associated with the object, on the basis of the shape box.

Tracks as an object tracking result may be classified into specific objects such as a pedestrian, a guardrail and an automobile (S40), and may be applied to control a driving function.

In the above-described object detection method using a LiDAR sensor, the object tracking unit 230 may generate motion vectors using LiDAR point data of an object at a current time point and a previous time point, and may extract heading information of the object from the generated motion vectors.

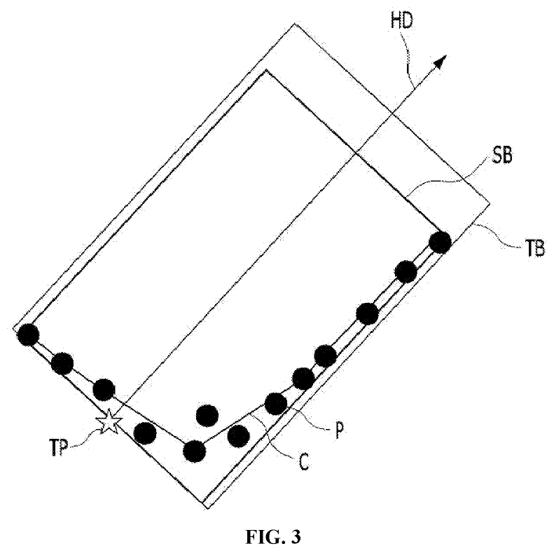

FIG. 3 is a diagram for explaining a box detected by the LiDAR signal processing device 200.

Referring to FIG. 3, the object detection unit 220 may generate a contour C according to a predetermined rule for the cloud of points P. The contour C may provide shape information indicating what the shape of the points P constituting an object is.

Thereafter, the object detection unit 220 may generate a shape box SB on the basis of the shape information of the contour C generated by the clustered points P. The generated shape box SB may be determined as one object. The shape box SB may be a box generated by being fitted to the clustered points P, and the four sides of the shape box SB may not actually match the outermost portions of a corresponding object. The object tracking unit 230 generates a track box TB by selecting a box to be used to maintain tracking of a target object currently being tracked among shape boxes SB. The object tracking unit 230 may set the center of the rear surface of the shape box SB as a track point TP in order to track the object. When the track point TP may be set as the center of the rear surface of the shape box SB, an advantage may be provided in stably tracking an object because the density of LiDAR point data at the center of the rear surface on the basis of a position where the LiDAR sensor 100 may be mounted may be high. The object tracking unit 230 may extract heading information HD as a result of tracking the shape box SB.

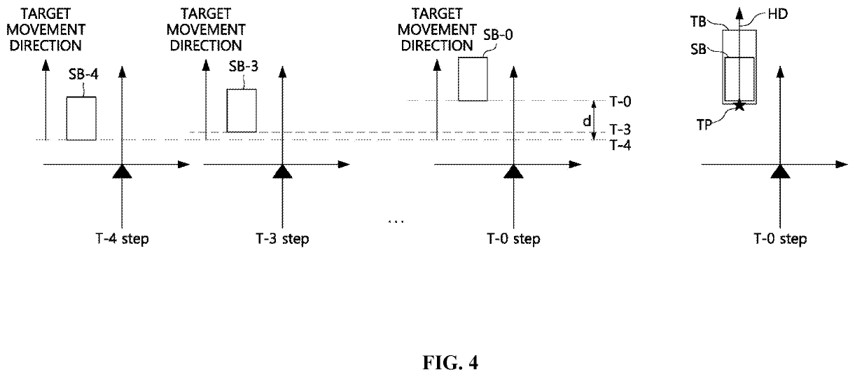

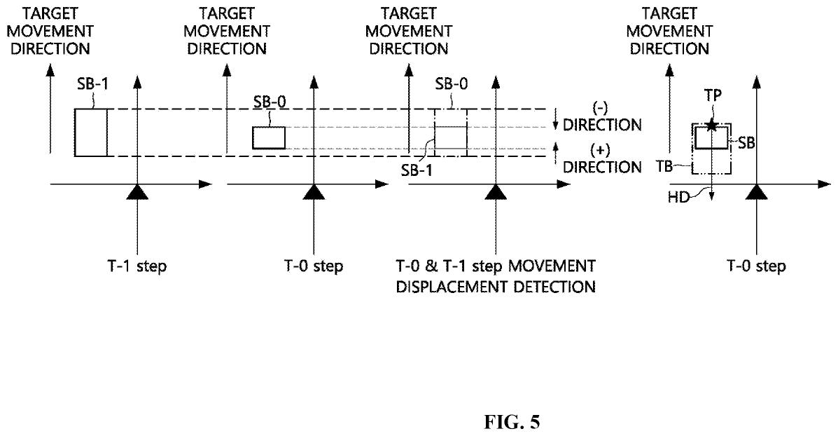

FIGS. 4 and 5 are diagrams for explaining heading information extraction methods according to comparative examples. According to the comparative examples, the heading information of an object may be detected on the basis of the shape of the object.

FIG. 4 is a diagram for explaining a method of updating heading information of a current step T-0 step to history information according to a first comparative example. In general, history information includes a maximum of five steps of information. That may be to say, information from the current step T-0 step to a previous step T-4 step may be accumulated. Thus, information such as the shape and position of a shape box SB-4 of the T-4 step, the shape and position of a shape box SB-3 of a T-3 step as a next step, and so forth may be accumulated and stored up to the current step T-0 step.

Heading information HD of the current step T-0 step may be detected on the basis of a movement displacement d of shape boxes SB-4 to SB-0 generated from the T-4 step to the T-0 step. The movement displacement d of a shape box SB may be detected on the basis of the shape of a shape box in each step.

Finally, at the current step T-0 step, the shape box SB and a track box TB of the T-0 step, the heading information HD generated on the basis of the movement displacement d of the shape box SB and a track point TP as the center of the rear surface of the track box TB in a movement direction may be stored. The size of the track box TB may be adjusted on the basis of a heading direction according to a classification of an object.

As in the first comparative example described above, the heading information of a track box of a current step may be extracted by detecting the movement displacement d of a shape box using information on the shape and position of a shape box at a previous step stored in history information.

FIG. 5 is a view for explaining a method of updating the heading information of a current step T-0 step to history information according to a second comparative example, illustrating a case where the size of a shape box generated at each step changes.

LiDAR point data may be affected by various factors such as the position, distance and speed of each of a LiDAR sensor and an object. In addition, due to the characteristics of a preprocessing and object detection process for LiDAR point data, even when the same object may be recognized, a difference may occur in a recognition result. Therefore, the shape of an object recognized at each step, that is, the size of a shape box, may be different. The second comparative example exemplifies a heading information extraction result when the sizes of shape boxes recognized at respective steps of an object may be different.

Referring to FIG. 5, for a target actually moving in a + direction, the size of a shape box SB-0 recognized at a current step T-0 step may be recognized to be smaller than the size of a shape box SB-1 recognized at a previous step T-1 step. When the movement displacement between the current step T-0 step and the previous step T-1 step may be detected in a state in which the sizes of shape boxes may be differently recognized as described above, a box side close to a reference line among box sides may be detected as having moved in the + direction, and a box side far from the reference line may be detected as having moved in a − direction. Since a − direction displacement may be larger between two displacements, as a result, the heading information HD of the current step T-0 step may be determined as the − direction.

As in the comparative examples described above, when heading information may be generated on the basis of the shape of a shape box, a phenomenon in which the heading information may be erroneously detected as a direction opposite to an actual movement direction of an object may occur. If the object may be a slowly moving object or a pedestrian, the angle change of a shape box may seriously occur. When heading information may be extracted on the basis of a shape box for an object in which a shape change seriously occurs as described above, a phenomenon in which heading information may be erroneously detected as in the second comparative example may be checked. In order to prevent such an erroneous detection phenomenon, in an embodiment, heading information may be generated using not the shape of an object but the LiDAR point data of the object.

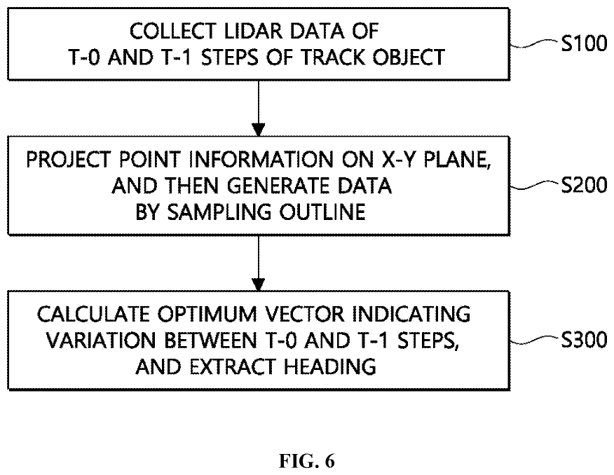

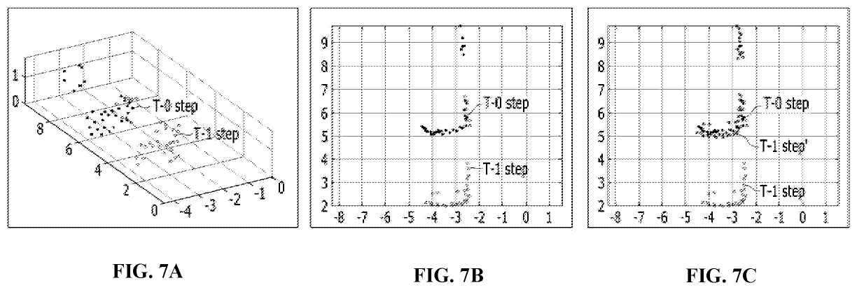

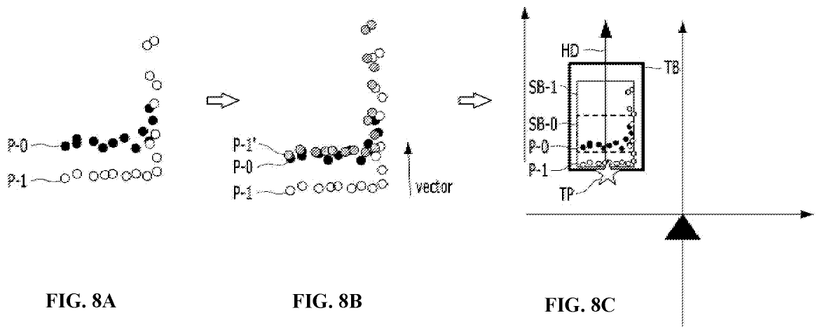

FIGS. 6 to 8C are diagrams for explaining a heading information extraction method according to an embodiment. FIG. 6 is a flowchart of a data processing method for extracting heading information according to the embodiment, FIGS. 7A-C are diagrams showing the states of LiDAR point data in respective data processing acts of FIG. 6, and FIGS. 8A-8C are diagrams for explaining a method of processing LiDAR point data in act S200 and act S300 of FIG. 6.

Referring to FIG. 6, in order to extract heading information according to the embodiment, first, the LiDAR point data of a current step T-0 step and a previous step T-1 step of an object to track may be collected (S100). FIG. 7A is a diagram showing the LiDAR point data of the current step T-0 step and the previous step T-1 step. Referring to FIG. 7A, the information of the LiDAR point data may be collected as information of a three-dimensional (3D) X, Y and Z coordinate system.

After projecting the LiDAR point data of the current step T-0 step and the previous step T-1 step on a two-dimensional (2D) X-Y plane from the three-dimensional (3D) coordinate system, a data set may be generated by sampling a point outline (S200). FIG. 7B may be a diagram showing a result of projecting the LiDAR point data of the current step T-0 step and the previous step T-1 step on the two-dimensional (2D) X-Y plane.

For the LiDAR point data projected on the two-dimensional (2D) X-Y plane, optimal vectors that may represent the variations between the current step T-0 step and the previous step T-1 step may be calculated, and, on the basis of the optimal vectors, heading information HD of the current step T-0 step may be extracted (S300). The optimal vectors may be extracted as vectors that may enable the point data of the previous step T-1 step to be maximally fitted to the LiDAR points of the current step T-0 step when the vectors may be applied to the point data of the previous step T-1 step. FIG. 7C shows the LiDAR point data of the current step T-0 step and the previous step T-1 step and predicted data T-1 step' calculated when the LiDAR point data of the previous step T-1 step may be moved by vector operation. The optimal vectors may be calculated as vectors that minimize the differences between the predicted data T-1 step' and the data of the current step T-0 step. Thereafter, on the basis of the calculated optimal vectors, the heading information HD of the current step T-0 step may be extracted.

FIGS. 8A-8C is a diagram for explaining the LiDAR point data processing method of the act S200 and the act S300 of FIG. 6.

FIG. 8A is a diagram showing a result of projecting LiDAR points P-0 of the current step T-0 step and LiDAR points P-1 of the previous step T-1 step on a two-dimensional plane. By applying motion vectors to the LiDAR points P-1 of the previous step T-1, the LiDAR points P-1 may be moved by the values of the motion vectors. Therefore, vectors capable of moving the LiDAR points P-1 of the previous step T-1 step as close as possible to the positions of the LiDAR points P-0 of the current step T-0 step may be calculated as optimal vectors.

FIG. 8B shows predicted LiDAR points P-1′ which may be calculated when an operation may be performed by applying the optimal vectors to the LiDAR points P-1 of the previous step T-1 step. The optimal vectors may be calculated as values capable of minimizing the differences between the predicted LiDAR points P-1′ and the LiDAR points P-0 of the current step T-0 step. As a method for calculating optimal vectors, well-known techniques for calculating a function capable of registering two point groups may be applied. For example, optimal vectors may be calculated by applying an iterative closest point (ICP) filter used for registering three-dimensional point clouds. ICP as an algorithm for registering two point clouds scanned at different time points or points with respect to one object may be widely used when matching point data. In the embodiment, the ICP filter may fix the LiDAR points P-0 of the current step T-0 step, and may extract optimal vectors capable of enabling the LiDAR points P-1 of the previous step T-1 step to be fitted to the current step T-0 step while having minimum errors, by using the least squares method. The least squares method may be one of statistical methods for optimizing an estimated value, on the basis of the principle of minimizing the sum of square deviations between a measured value and the estimated value. Since the detailed processing method of such an ICP filter may be irrelevant to the gist of the present embodiment, detailed description thereof will be omitted. In addition, a method of calculating optimal vectors in the embodiment may not be limited to the ICP filter, and various techniques for calculating optimal vectors capable of registering the LiDAR points P-1 of the previous step T-1 step to the LiDAR points P-0 of the current step T-0 step may be applied.

FIG. 8C shows track information which may be finally outputted after the heading information HD may be extracted using the optimal vectors. The heading information HD may be determined as facing forward according to the direction of the optimal vectors. As shown in FIG. 8C, even when the size of a shape box SB-0 recognized in the current step T-0 step may be smaller than the size of a shape box SB-1 recognized in the previous step T-1 step, the heading information HD may be determined on the basis of the LiDAR points P-0 of the current step T-0 step and the LiDAR points P-1 of the previous step T-1 step, regardless of the shape of a shape box. Thus, it may be possible to extract the heading information HD corresponding to the actual movement direction of an object.

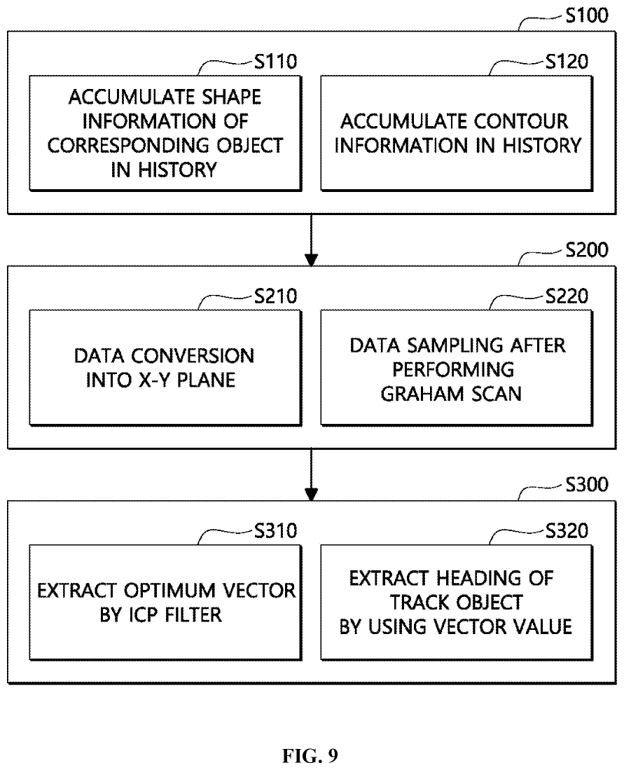

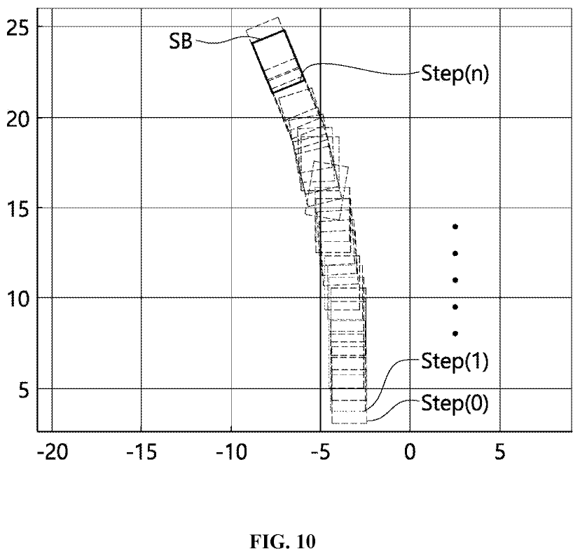

FIG. 9 is a flowchart showing in detail the heading information extraction method according to the embodiment of FIG. 6, and FIGS. 10 to 14 are diagrams for explaining respective processing acts of FIG. 9.

Referring to FIG. 9, the act S100 corresponds to act of collecting the LiDAR point data of the current step T-0 step and the previous step T-1 step of the object to track (see FIG. 6). The act S100 may include accumulating the shape information of the object to track in history information (S110) and accumulating contour point information in the history information (S120). Both the shape information and contour information of the object to track may be collected as information of a three-dimensional (3D) X, Y and Z coordinate system.

When accumulating the shape information of the object to track according to the act S110, the information of a shape box SB for each step may be stored as shown in FIG. 10. Furthermore, in each step, the three-dimensional point data of the shape box, the size of the shape box and information on a center point may be accumulated as the shape information of the object to track.

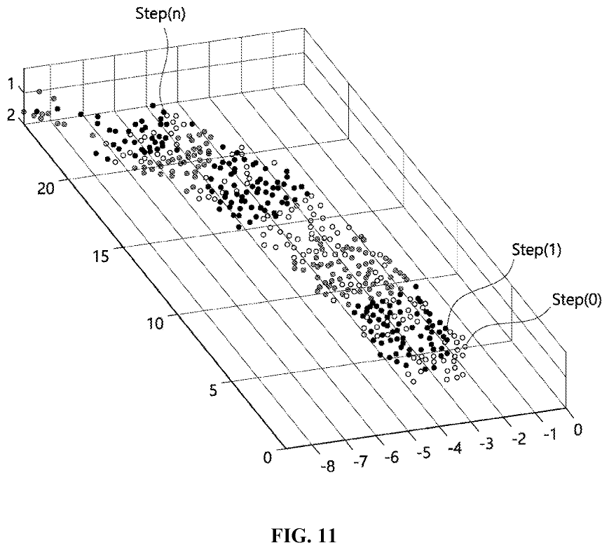

Thereafter, when accumulating the contour point information in the history information according to the act S120, information on points corresponding to the contour of the object in each step may be stored. A contour may be determined by clustered points, and the contour of the object in each step has the form of point data of a three-dimensional coordinate system as shown in FIG. 11. Therefore, the contour point information in each step may be stored as the data of the three-dimensional coordinate system.

Referring to FIG. 9, the act S200 corresponds to act of projecting the LiDAR point data of the current step T-0 step and the previous step T-1 step on a two-dimensional (2D) X-Y plane and generating a data set by sampling a point outline (see FIG. 6). The act S200 may include converting the LiDAR point data into the two-dimensional (2D) X-Y plane (S210) and sampling the data of an outline by performing Graham scan (S220).

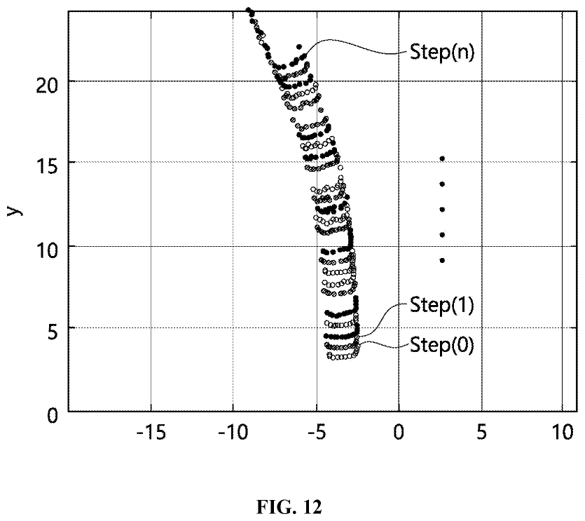

The act of converting the LiDAR point data into the two-dimensional X-Y plane according to the act S210 may be act of converting the contour point information stored as the data of the three-dimensional coordinate system in each step into the two-dimensional X-Y plane. FIG. 12 is a diagram showing the contour point information on the two-dimensional X-Y plane. When the contour point data of the three-dimensional coordinate system shown in FIG. 11 is projected onto the two-dimensional X-Y plane, contour point information of a two-dimensional coordinate system may be obtained as shown in FIG. 12.

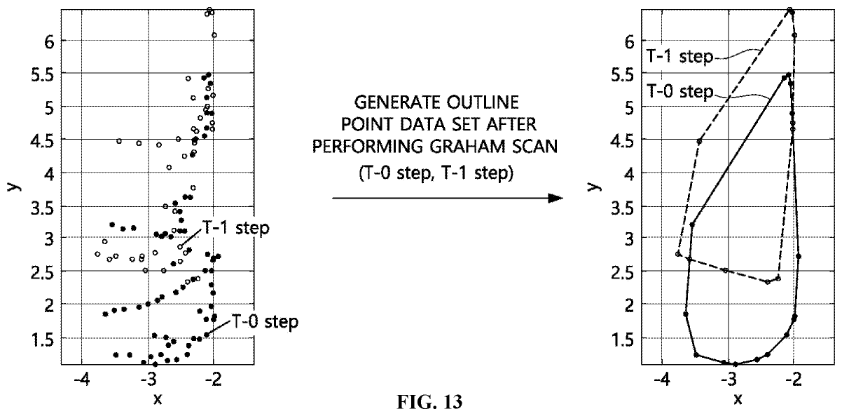

Thereafter, for the contour point information of the two-dimensional coordinate system, the data of the outline may be sampled by performing the Graham scan according to the act S220. Graham scan as an algorithm that generates a polygon of a minimum size including all given points may be a well-known technique used when processing point cloud data. The present embodiment exemplifies the use of the Graham scan technique to extract an outline for the contour points of the two-dimensional coordinate system and sample the data of the outline, but may not be limited thereto. Various techniques capable of deriving the outline of a cluster of points may be applied. Referring to FIG. 13, when the Graham scan may be performed for the contour point information of the two-dimensional coordinate system of the current step T-0 step and the previous step T-1 step, the data of the outline of the contour points of the current step T-0 step and the outline of the contour points of the previous step T-1 step may be sampled.

Referring to FIG. 9, the act S300 includes calculating the optimal vectors and extracting the heading information HD of the current step T-0 step on the basis of the optimal vectors (see FIG. 6). The act S300 may include extracting the optimal vectors on the basis of the sampling data of the outline of the contour points of the current step T-0 step and the sampling data of the outline of the contour points of the previous step T-1 step (S310) and extracting the heading data HD of the object to track by using the values of the extracted vectors (S320).

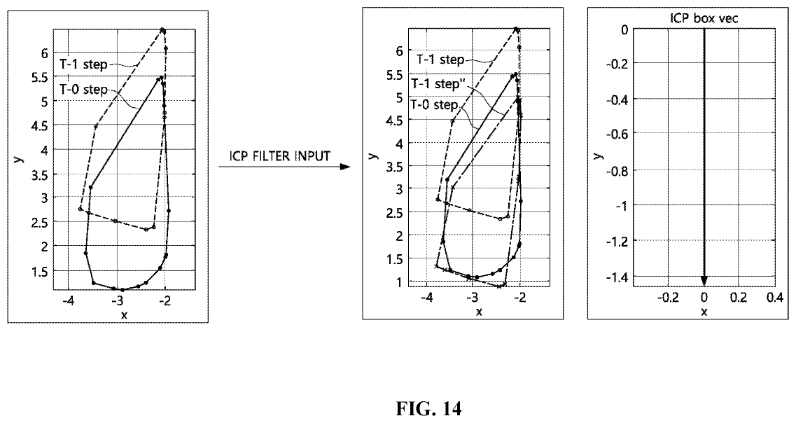

In the act of extracting the optimal vectors according to the act S310, by transferring the sampling data of the current step T-0 step and the sampling data of the previous step T-1 step as the inputs of the iterative closest point (ICP) filter, results thereof may be obtained as the optimal vectors. Referring to FIG. 14, the ICP filter may be provided in the form of a program for extracting vectors capable of registering two point clouds.

The ICP filter may receive the sampling data of the current step T-0 step and the sampling data of the previous step T-1 step, may fix the sampling data of the current step T-0 step, and then, may extract the optimal vectors capable of enabling the sampling data of the previous step T-1 step to be fitted to the sampling data of the current step T-0 step while having minimum errors, by using the least squares method. In FIG. 14, vectors that minimize the errors between the predicted data T-1 step′ obtained by performing a vector operation on the sampling data of the previous step T-1 step and the sampling data of the current step T-0 step may be calculated as the optimal vectors.

Thereafter, the heading data HD of the object to track may be extracted using the values of the extracted optimal vectors. Since the optimal vectors extracted in FIG. 14 are − direction vectors, the heading data HD may be determined as having a − direction.

As may be apparent from the above description, in order to prevent a phenomenon in which erroneous detection of the heading of an object to be tracked occurs since, due to the characteristics of a LiDAR sensor, change in the shape of the object occurs greatly depending on a surface to be recognized by the sensor, the present embodiment proposes a method of detecting heading information on the basis of LiDAR points of an object. In the present embodiment, by deriving optimal vectors capable of representing movement variations of LiDAR point data between a current time point and a previous time point and by extracting heading information on the basis of the optimal vectors, it may be possible to obtain accurate heading information even for an object whose shape change occurs greatly, such as a slowly moving object, a pedestrian and a bicycle.

Although embodiments have been described with reference to a number of illustrative embodiments thereof, it should be understood that numerous other modifications and embodiments may be devised by those skilled in the art that will fall within the spirit and scope of the principles of this disclosure. More particularly, various variations and modifications may be possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An object detection method of a vehicle LiDAR system, comprising:
calculating, based on LiDAR point data of a previous time point and LiDAR point data of a current time point of an object to track, a representative vector value representing a movement variation of the LiDAR point data from the previous time point to the current time point; and
extracting heading information of the object to track based on the representative vector value.

2. The object detection method according to claim 1, wherein the calculating of, based on the LiDAR point data of the previous time point and the LiDAR point data of the current time point of the object to track, the representative vector value representing the movement variation of the LiDAR point data from the previous time point to the current time point comprises:
collecting the LiDAR point data of the previous time point and the current time point of the object to track;
sampling, based on the LiDAR point data, data of an outline of the object to track of the previous time point and an outline of the object to track of the current time point; and
calculating a vector value capable of fitting sampling data of the previous time point based on sampling data of the current time point, as the representative vector value.

3. The object detection method according to claim 2, wherein the collecting of the LiDAR point data of the previous time point and the current time point of the object to track comprises:
obtaining information on a shape box of a three-dimensional coordinate system of the object to track; and
obtaining contour information of a three-dimensional coordinate system associated with the shape box of the three-dimensional coordinate system.

4. The object detection method according to claim 3, wherein the sampling of, based on the LiDAR point data, the data of the outline of the object to track of the previous time point and the outline of the object to track of the current time point comprises:
converting the contour information of the three-dimensional coordinate system of each of the previous time point and the current time point into contour information of a two-dimensional coordinate system; and
sampling the data of the outline based on the contour information converted into the two-dimensional coordinate system.

5. The object detection method according to claim 4, wherein the sampling of the data of the outline based on the contour information converted into the two-dimensional coordinate system comprises:
sampling the data of the outline by performing Graham scan for the contour information.

6. The object detection method according to claim 4, wherein the calculating of the vector value capable of fitting the sampling data of the previous time point based on the sampling data of the current time point, as the representative vector value comprises:
fixing the data of the outline of the current time point as reference data; and
calculating a vector value enabling the data of the outline of the previous time point to be fitted to the data of the outline of the current time point while having a minimum error, as the representative vector value.

7. The object detection method according to claim 4, wherein the calculating of the vector value capable of fitting the sampling data of the previous time point based on the sampling data of the current time point, as the representative vector value comprises:
inputting the data of the outline of the current time point and the data of the outline of the previous time point, as inputs of an iterative closest point (ICP) filter; and
applying an output of the ICP filter as the representative vector value.

8. The object detection method according to claim 1, wherein the extracting of the heading information of the object to track based on the representative vector value comprises:
setting the heading information to a direction the same as the representative vector value.

9. A non-transitory computer-readable recording medium recorded with a program for executing an object detection method of a vehicle LiDAR system, implementing:
a function of calculating, based on LiDAR point data of a previous time point and LiDAR point data of a current time point of an object to track, a representative vector value representing a movement variation of the LiDAR point data from the previous time point to the current time point; and
a function of extracting heading information of the object to track based on the representative vector value.

10. A vehicle LiDAR system comprising:
a LiDAR sensor; and
a LiDAR signal processing device configured to calculate, based on LiDAR point data of a previous time point and LiDAR point data of a current time point of an object to track obtained through the LiDAR sensor, a representative vector value representing a movement variation of the LiDAR point data from the previous time point to the current time point, and extract heading information of the object to track based on the representative vector value.

11. The vehicle LiDAR system according to claim 10, wherein the LiDAR signal processing device is configured to collect the LiDAR point data of the previous time point and the current time point of the object to track, sample, based on the LiDAR point data, data of an outline of the object to track of the previous time point and an outline of the object to track of the current time point, and then, calculate a vector value capable of fitting sampling data of the previous time point based on sampling data of the current time point, as the representative vector value.

12. The vehicle LiDAR system according to claim 11, wherein the LiDAR signal processing device is configured to obtain information on a shape box of a three-dimensional coordinate system of the object to track, and obtain contour information of a three-dimensional coordinate system associated with the shape box of the three-dimensional coordinate system.

13. The vehicle LiDAR system according to claim 12, wherein the LiDAR signal processing device is configured to convert the contour information of the three-dimensional coordinate system of each of the previous time point and the current time point into contour information of a two-dimensional coordinate system, and sample the data of the outline based on the contour information converted into the two-dimensional coordinate system.

14. The vehicle LiDAR system according to claim 13, wherein the LiDAR signal processing device is configured to sample the data of the outline by performing Graham scan for the contour information.

15. The vehicle LiDAR system according to claim 13, wherein the LiDAR signal processing device is configured to fix the data of the outline of the current time point as reference data, and calculate a vector value enabling the data of the outline of the previous time point to be fitted to the data of the outline of the current time point while having a minimum error, as the representative vector value.

16. The vehicle LiDAR system according to claim 13, wherein the LiDAR signal processing device comprises an iterative closest point (ICP) filter which is configured to receive the data of the outline of the current time point and the data of the outline of the previous time point and output the representative vector value.

17. The vehicle LiDAR system according to claim 10, wherein the LiDAR signal processing device is configured to set the heading information to a direction the same as the representative vector value.
